(19) United States
(12) Patent Application Publication
(10) Pub. No.: US 2018/0202507 A1
(43) Pub. Date: Jul. 19, 2018

(54) VALVE STRUCTURE OF SHOCK ABSORBER

(71) Applicant: MANDO CORPORATION, Gyeonggi-do (KR)

(72) Inventor: Nam Ho KIM, Gyeonggi-do (KR)

(21) Appl. No.: 15/868,865

(22) Filed: Jan. 11, 2018

(30) Foreign Application Priority Data
Jan. 13, 2017 (KR) 10-2017-0006337

(51) Int. Cl. F16F 9/348

(52) U.S. Cl. CPC F16F 9/3484

(57) ABSTRACT

The present disclosure relates to a valve structure of a shock absorber in which ride comfort degradation may be prevented by forming a first flow path and a second flow path independently formed without associating them to each other such that disks do not sequentially open and cause a blow-off phenomenon, and a degree of tuning freedom may be improved by forming the first flow path and the second flow path independently without interference.

### CROSS-REFERENCE TO RELATED APPLICATION

This application claims priority to and the benefit of Korean Patent Application No. 2017-0006337 filed on Jan. 13, 2017, the disclosure of which is incorporated herein by reference in its entirety.

### BACKGROUND

### 1. Field of the Invention

The present disclosure relates to a valve structure of a shock absorber, and more particularly, to a valve structure of a shock absorber in which a blow-off phenomenon and ride comport degradation due to the blow-off phenomenon are prevented because a first flow path and a second flow path are individually opened and closed by forming an independent opening and closing structure such that the first flow path is not associated with the second flow path, and a degree of tuning freedom is improved because the first flow path and the second flow path are independently formed without interference.

### 2. Discussion of Related Art

Generally, a shock absorber absorbs and relaxes vertical vibrational energy transmitted to wheels due to an irregular road surface in order to prevent vibration from being transmitted to a vehicle body directly.

Such a shock absorber includes a cylinder filled with an acting fluid such as an oil, a piston valve moveably installed in the cylinder and configured to divide the cylinder into a compression chamber and an extension chamber, a piston rod connected to a piston valve, and a body valve fixed to a lower portion of the cylinder.

Among them, in a conventional piston valve, compression and extension flow paths configured to allow a fluid to flow are formed, a disk valve having disks on an upper or lower surface thereof is installed, and the disk valve provides resistance against the fluid flowing through the compression and extension flow paths and generates a damping force.

In addition, the conventional piston valve has a flow path opening structure in which, after two different disks vertically spaced apart from each other open an outlet of a flow path for a first time, the two different disks open the outlet for a second time to move the fluid to the compression chamber or the extension chamber.

However, since the conventional piston valve has a structure in which one or more flow paths are associated, the conventional piston valve does not have an independent performance curve. Accordingly, there are many limitations in independent tuning and free tuning, and there is a risk of an occurrence of a blow-off point phenomenon and a degradation of ride comfort during the process of opening and closing the disk.

A related art related to the present disclosure is disclosed in Korean Patent Laid-Open No. 10-2010-0104672 (Sep. 29, 2010) “VALVE APPARATUS OF SHOCK ABSORBER”.

### SUMMARY OF THE INVENTION

The present disclosure is directed to a valve structure of a shock absorber capable of preventing a blow-off phenomenon and ride comport degradation due to the blow-off phenomenon by forming an independent opening and closing structure in which a first flow path is not connected to a second flow path and the first flow path and the second flow path are individually opened and closed, and of improving a degree of tuning freedom by forming the first flow path and the second flow path independently without interference.

According to an aspect of the present disclosure, there is provided a valve structure of a shock absorber including a main body configured to divide an inside of a cylinder into a compression chamber and an extension chamber, at least one first flow path radially disposed about a vertical center of the main body and including an upper end and a lower end on which an inlet and an outlet are correspondingly formed, an auxiliary disk including an edge configured to be in close contact with any one of an upper surface and a lower surface of the main body in the compression chamber to block the outlet of the first flow path and including at least one slit formed along the edge to open the lower end of the first flow path during an extension stroke, at least one second flow path radially disposed about the vertical center of the main body along an outer side of the first flow path and including an upper end and a lower end wherein the second flow path vertically passes through the upper end and the lower end, at least one compression side main disk having a diameter greater than that of the auxiliary disk, disposed below the auxiliary disk, including an edge in close contact with an outlet of the second flow path, and configured to open the outlet of the second flow path located in the compression chamber during the extension stroke, and at least one extension side main disk including an edge in close contact with the upper surface of the main body in the extension chamber, in close contact with the outlet of the second flow path and configured to open the outlet of the second flow path located in the extension chamber during a compression stroke.

Here, the inlet and the outlet may be alternately disposed in the upper surface and the lower surface of the main body.

In addition, the outlet and the inlet may be correspondingly disposed along the same line which extends toward the compression chamber and the extension chamber.

In addition, extension portions may be formed to protrude from edge portions of the outlet of the second flow path at the upper surface and the lower surface of the main body, and the extension portions may include protruding ends in close contact with the edges of the compression side main disk and the extension side main disk such that the inlet is separated from the main body.

In addition, the first flow path and the second flow path may be spaced apart from each other to form independent flow paths.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a cross-sectional view illustrating a compression stroke of a valve structure of a shock absorber according to the present disclosure;

FIG. 2 is a cross-sectional view illustrating an extension stroke of the valve structure of the shock absorber according to the present disclosure;

FIG. 3 is an exploded perspective view illustrating a main body, auxiliary disks, and compression side main disks of the valve structure of the shock absorber according to the present disclosure; and

FIG. 4 is a plan view illustrating first flow paths and second flow paths of the valve structure of the shock absorber according to the present disclosure.

### DETAILED DESCRIPTION OF EXEMPLARY EMBODIMENTS

Hereinafter, the exemplary embodiment of the present disclosure will be described in detail with reference to the accompanying drawings.

Advantages and features of the present disclosure and methods of achieving the same should be clearly understood with reference to the accompanying drawings and the following detailed embodiments.

However, the present disclosure is not limited to the embodiments to be disclosed, but may be implemented in various different forms. The embodiments are provided in order to fully explain the present disclosure and fully explain the scope of the present disclosure to those skilled in the art. The scope of the present disclosure is defined by the appended claims.

In addition, in descriptions of the invention, when it is determined that related well-known technology and the like unnecessarily obscure the gist of the invention, the detailed descriptions will be omitted.

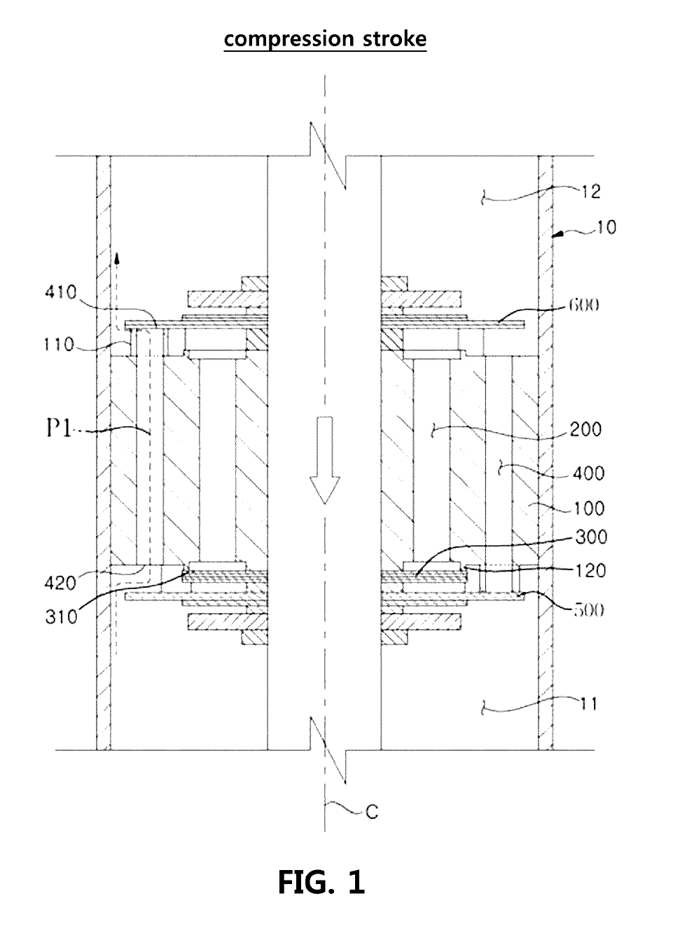

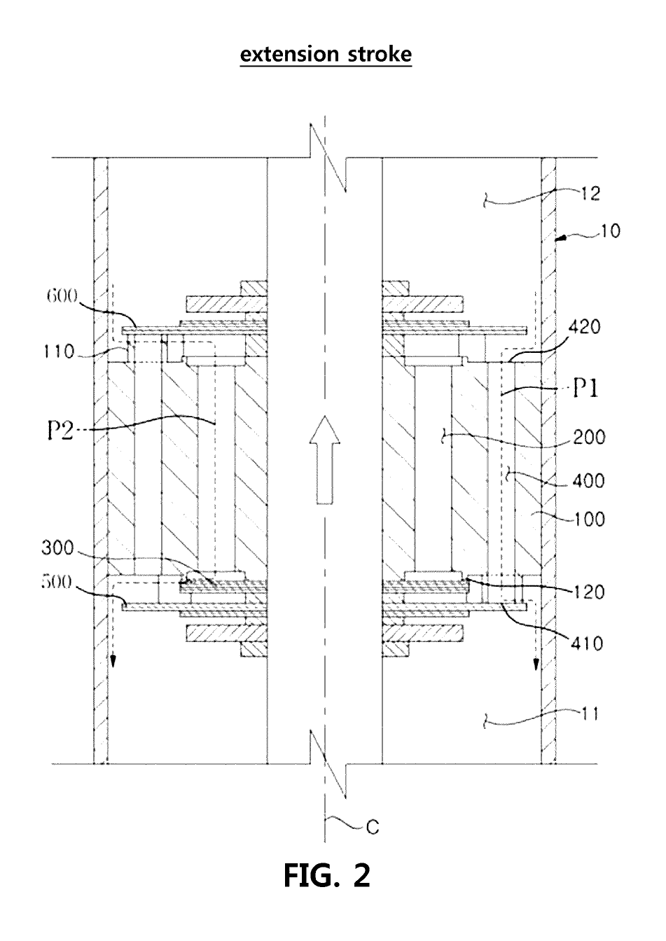

FIG. 1 is a cross-sectional view illustrating a compression stroke of a valve structure of a shock absorber according to the present disclosure, and FIG. 2 is a cross-sectional view illustrating an extension stroke of the valve structure of the shock absorber according to the present disclosure.

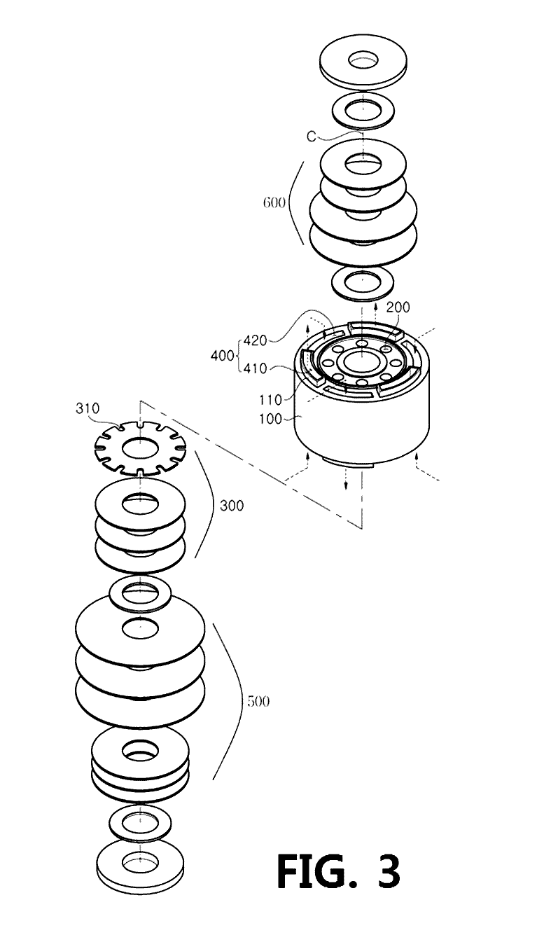

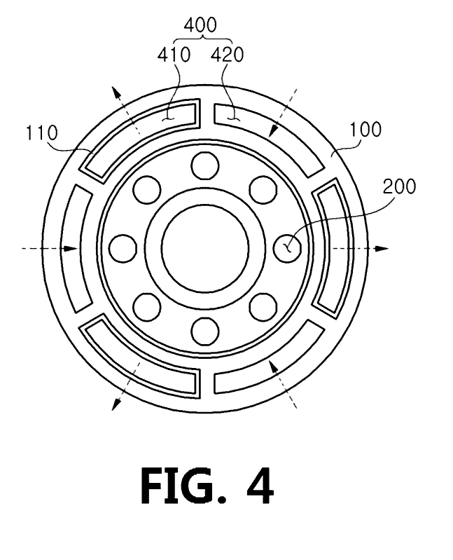

In addition, FIG. 3 is an exploded perspective view illustrating a main body, auxiliary disks, and compression side main disks of the valve structure of the shock absorber according to the present disclosure, and FIG. 4 is a plan view illustrating first flow paths and second flow paths of the valve structure of the shock absorber according to the present disclosure.

As illustrated in FIGS. 1 to 4, the valve structure of the shock absorber according to the present disclosure includes a main body 100, first flow paths 200, auxiliary disks 300, second flow paths 400, compression side main disks 500, and extension side main disks 600.

First, the main body 100 divides a compression chamber 11 from a extension chamber 12 in a cylinder 10, and the main body 100 has a cylindrical shape.

Here, the main body 100 moves toward the compression chamber 11 and the extension chamber 12 in a state in which a side surface of the main body 100 is in close contact with an inner circumferential surface of the cylinder 10.

In addition, a hollow configured to vertically pass through the main body 100 is formed around a center C of the main body 100 such that one end of a piston rod 20 inserted into the cylinder 10 passes through and is coupled to the main body 100.

In addition, contact portions 120 for supporting edge portions of the auxiliary disks 300, which will be described below, are formed to protrude from an upper surface and a lower surface of the main body 100.

Here, the contact portions 120 are formed between the first flow paths 200 and the second flow paths 400 which will be described below, and the contact portions 120 are continuously formed in a circumferential direction about the vertical center C of the main body 100.

Particularly, extension portions 110 configured to protrude from edge portions of outlets 410, which will be described below, are formed at the upper surface and the lower surface of the main body 100.

Protruding one ends of the extension portions 110 are in close contact with one surfaces of the compression side main disks 500 and the extension side main disks 600 which will be described below.

Here, inlets 420 of the second flow paths 400, which will be described below, are spaced apart from the compression side main disks 500 and the extension side main disks 600.

In addition, outer side surfaces of the extension portions 110 are spaced apart from the inner circumferential surface of the cylinder 10 such that a fluid flows upward or downward along a side of the cylinder 10.

The first flow paths 200 move a fluid in a direction opposite a stroke direction of the main body 100, and both ends of the first flow paths 200 communicate with the compression chamber 11 and the extension chamber 12.

Here, the first flow paths 200 are vertically formed to have a length thereof toward the compression chamber 11 and the extension chamber 12, and the first flow paths 200 are radially disposed about the vertical center C of the main body 100.

In addition, a cross section of the first flow path 200 has a horizontal circular shape, and the first flow paths 200 are disposed to be spaced apart from each other in a circumferential direction of the main body 100.

An edge of the auxiliary disk 300 is in close contact with the lower surface of the main body 100 in the compression chamber 11 to block the outlets of the first flow paths 200.

Here, the auxiliary disks 300 may have a disk shape of which diameter is less than that of one surface of the main body 100, and at least one auxiliary disk 300 may be stacked on and coupled to the upper surface and the lower surface of the main body 100.

In addition, a hollow configured to vertically pass through the auxiliary disks 300 is formed around the vertical center C of the auxiliary disks 300 such that the one end of the piston rod 20 located in the cylinder 10 passes through and is coupled to the main body 100.

In addition, at least one slit 310 is concavely formed along the edge of the auxiliary disk 300 such that lower ends of the first flow paths 200 are opened during the extension stroke.

Although it is preferable that the slits 310 be formed to be separated by the same distance from each other along the edge of the auxiliary disk 300, the slits 310 may be variously disposed.

Here, one ends of the slits 310, which concavely extend toward a vertical center C of the auxiliary disk 300, may communicate with the lower ends of the first flow paths 200, and the other ends thereof located at an opposite side thereof may communicate with the compression chamber 10.

For example, a fluid introduced through the inlets 420 of the first flow paths 200 of the extension chamber 12 flows to the compression chamber 11 via the slits 310 during the extension stroke.

In addition, in a case in which a plurality of auxiliary disks 300 are stacked in a multilayer, the slits 310 may be formed in the auxiliary disk 300 in close contact with the one surface of the main body 100 among the auxiliary disks 300.

The second flow paths 400 move a fluid in a direction opposite a stroke direction of the main body 100, and upper ends and lower ends of the second flow paths 400 communicate with the compression chamber 11 and the extension chamber 12, respectively.

Here, the second flow paths 400 are vertically formed to have a length in a direction from the compression chamber 11 to the extension chamber 12, and a horizontal cross-section of the second flow path 400 has a circular shape.

In addition, the second flow paths 400 are disposed to be radial about the vertical center C of the main body 100, and the second flow paths 400 are disposed to be spaced apart from each other along an outer side of the first flow paths 200 in order to form independent flow paths.

Here, the second flow paths 400 are located to be spaced apart from the inner circumferential surface of the cylinder 10 such that a fluid flows upward or downward along sides of the second flow paths 400.

In addition, the second flow paths 400 are disposed to be spaced apart from each other in the circumferential direction of the main body 100, and the second flow paths 400 are spaced a constant distance apart from each other along a circumference of the main body 100.

In addition, the second flow paths 400 may be formed to have a predetermined length in the circumferential direction of the main body 100, and the second flow paths 400 may extend to have a curvature the same as that of the circumference of the main body 100.

In addition, it is preferable that an even number of the second flow paths 400 be disposed in the circumferential direction of the main body 400, and the inlets 420 and the outlets 410 of the second flow paths 400 be alternately disposed at the upper surface and the lower surface of the main body 100.

The outlets 410 of the second flow paths 400 are located at locations in which a fluid is discharged, protrude from the upper surface and the lower surface of the main body 100, and are in close contact with one surfaces of the compression side main disks 500 and the extension side main disks 600 which will be described below.

Here, the extension portions 110 protrude from the upper surface and the lower surface of the main body 100, and the extension portions 110 are formed along edges of the outlets 410 of the second flow paths 400.

The extension portions 110 have protruding ends configured to be in close contact with edges of one surfaces of the compression side main disk 500 and the extension side main disk 600.

In addition, the extension portions 110 separate the compression side main disks 500 and the extension side main disks 600 from the main body 100.

Accordingly, the outlets 410 of the second flow paths 400 allow a fluid in the compression chamber 11 or the extension chamber 12 to be discharged to the extension chamber 12 or the compression chamber 11 located at an opposite side thereof during the compression stroke and the extension stroke.

The inlets 420 of the second flow paths 400 are disposed at locations at which a fluid is introduced, and the second flow paths 400 open toward the upper surface and the lower surface of the main body 100.

Here, the second flow paths 400 allow a fluid in the compression chamber 11 or the extension chamber 12 to be discharged to the extension chamber 12 or the compression chamber 11 located at an opposite side thereof during the compression and the extension stroke.

In addition, the inlets 420 and the outlets 410 of the second flow paths 400 are correspondingly disposed along the same line that extends toward the compression chamber 11 and the extension chamber 12.

For example, in a case in which the inlets 420 of the second flow paths 400 are formed toward the extension chamber 12, the outlets 410 of the second flow paths 400 are formed toward the compression chamber 11.

That is, since step structures are formed between the inlets 420 of the second flow paths 400 and an end of the extension portions 110, a predetermined gap through which a fluid is introduced is formed between the inlets 420 and the one surfaces of the compression side main disks 500.

That is, in a case in which the main body 100 performs the compression stroke and the extension stroke, a fluid introduced through the inlets 420 of the second flow paths 400 flows to the compression chamber 11 or the extension chamber 12 via the outlets 410 located at the opposite side thereof.

The compression side main disks 500 are to be in close contact with the lower surface of the main body 100 in the compression chamber 11, and the compression side main disk 500 disposed below the auxiliary disk 300 has a diameter greater than those of the auxiliary disks 300.

Here, the edge portions of the compression side main disks 500 are in close contact with the outlets 410 of the second flow paths 400, and open the outlets 410 of the second flow paths 400 located in the compression chamber 11 during the extension stroke.

In addition, a hollow configured to vertically pass through the compression side main disks 500 is formed around a vertical center C of the compression side main disks 500 such that the one end of the piston rod 20 located in the cylinder 10 passes through and is coupled to the main body 100.

Such compression side main disks 500 open the outlets 410 of the second flow paths 400 located at a position opposite a stroke direction to generate a damping force.

Meanwhile, a groove (not shown) may be concavely formed in an edge portion of the main body 100 in close contact with edges of the compression side main disks 500 such that a fluid flows to the compression chamber 11 via the outlets 410.

The extension side main disk 600 is to be in close contact with the upper surface of the main body 100 in the extension chamber 12, and the extension side main disks 600 have a disk shape having a diameter less than that of the one surface of the main body 100.

Here, at least one of the extension side main disks 600 is stacked on and coupled to the upper surface and the lower surface of the main body 100.

In addition, a hollow configured to vertically pass through the extension side main disks 600 is formed around the vertical center C of the extension side main disks 600 such that the one end of the piston rod 20 located in the cylinder 10 passes through and is coupled to the main body 100.

Such extension side main disks 600 open the outlets 410 of the second flow paths 400 located at a location opposite a stroke direction to generate a damping force.

Meanwhile, a groove (not shown) is concavely formed in the edge portion of the main body 100 in close contact with edges of the extension side main disks 600 to allow a fluid to flow to the compression chamber 11 or the extension chamber 12 via the outlets 410.

Meanwhile, as illustrated in FIGS. 1 to 3, a first washer for maintaining a gap between the auxiliary disk 300 and the compression side main disk 500 may be coupled therebetween, and a second washer and a nut for fixing may be coupled to a rear surface of the outermost compression side main disk 500 corresponding to a location of the first washer.

Hereinafter, operation of the valve structure of the shock absorber according to the present disclosure will be described below with reference to FIGS. 1 to 4. First, in a case in which the piston rod 20 performs the compression stroke, a fluid in the compression chamber 11 flows upward through the inlets 420 of the second flow paths 400 (P1) as illustrated in FIG. 1.

Next, the fluid introduced through the inlets 420 of the second flow paths 400 flows to the extension chamber 12 through a gap between the extension side main disk 600 and the outlets 410 (P1), and a damping force is generated during this process.

However, in a case in which the piston rod 20 performs the extension stroke, a fluid in the extension chamber 12 flows downward through the inlets 420 of the second flow paths 400 (P1) as illustrated in FIG. 2.

Next, the fluid introduced through the inlets 420 of the second flow paths 400 flows to the compression chamber 11 through gaps between the compression side main disks 500 and the outlets 410 (P1), and a damping force is generated during this process.

Simultaneously, the fluid in the extension chamber 12 is introduced through the inlets of the first flow paths 200, flows downward, and flows to the compression chamber 11 through gaps between the outlets of the first flow paths 200 and the compression side main disks 500.

Thus, in the present disclosure, since the independent second flow paths 400 are formed along outer sides of the first flow paths 200 through which a fluid flows during a stroke, the auxiliary disks 300, the compression side main disks 500, and the extension side main disks 600 are not sequentially opened, and thus ride comfort degradation due to a blow-off phenomenon can be prevented.

In addition, in the present disclosure, since the first flow paths 200 and the second flow paths 400 are independently formed without interference, damping forces thereof can be individually adjusted, and thus a degree of tuning freedom can be improved.

In addition, in the present disclosure, since the extension portions are formed in the main body 100 to form the inlets of the second flow paths 400, an additional retainer structure is not necessary, and thus a structure thereof can be simplified, a manufacturing cost can be decreased, the number of components can be decreased, and assembly can be facilitated.

Although the specific embodiment of the valve structure of a shock absorber of the present disclosure has been described, it is clear that various modifications will be made without departing the scope of the present disclosure.

Therefore, the scope of the present disclosure is defined not by the described embodiment but by the appended claims, and encompasses equivalents that fall within the scope of the appended claims.

That is, the above-described embodiments should be considered in a descriptive sense only and not for purposes of limitation. The scope of the present disclosure is defined not by the detailed description but by the appended claims, and encompasses all modifications and alterations derived from meanings, the scope and equivalents of the appended claims.

What is claimed is:

1. A valve structure of a shock absorber comprising:
a main body configured to divide an inside of a cylinder into a compression chamber and an extension chamber;
at least one first flow path radially disposed about a vertical center of the main body and including an upper end and a lower end on which an inlet and an outlet are correspondingly formed;
an auxiliary disk including an edge configured to be in close contact with any one of an upper surface and a lower surface of the main body in the compression chamber to block the outlet of the first flow path and including at least one slit formed along the edge to open the lower end of the first flow path during an extension stroke;
at least one second flow path radially disposed about the vertical center of the main body along an outer side of the first flow path and including an upper end and a lower end wherein the second flow path vertically passes through the upper end and the lower end;
at least one compression side main disk having a diameter greater than that of the auxiliary disk, disposed below the auxiliary disk, including an edge in contact with an outlet of the second flow path, and configured to open the outlet of the second flow path located in the compression chamber during the extension stroke; and
at least one extension side main disk including an edge in close contact with the upper surface of the main body in the extension chamber, in close contact with the outlet of the second flow path and configured to open the outlet of the second flow path located in the extension chamber during a compression stroke.

2. The valve structure of a shock absorber of claim 1, wherein the inlet and the outlet are alternately disposed in the upper surface and the lower surface of the main body.

3. The valve structure of a shock absorber of claim 2, wherein the outlet and the inlet are correspondingly disposed along the same line which extends toward the compression chamber and the extension chamber.

4. The valve structure of a shock absorber of claim 3, wherein:
extension portions are formed to protrude from edge portions of the outlet of the second flow path at the upper surface and the lower surface of the main body; and
the extension portions include protruding ends in close contact with the edges of the compression side main disk and the extension side main disk such that the inlet is separated from the main body.

5. The valve structure of a shock absorber of claim 1, wherein the first flow path and the second flow path are spaced apart from each other to form independent flow paths.
